(19) United States
(12) Patent Application Publication
(10) Pub. No.: US 2010/0176752 A1
(43) Pub. Date: Jul. 15, 2010

(54) EVENT BASED AMBIENT LIGHTING CONTROL

(75) Inventor: Dengzhai Xiong, Singapore (SG)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/294,621

(22) PCT Filed: Mar. 27, 2007
(86) PCT No.: PCT/IB2007/051074

§ 371 Date: Sep. 26, 2008

Related U.S. Application Data
(60) Provisional application No. 60/788,466, filed on Mar. 31, 2006.
(60) Provisional application No. 60/866,652, filed on Nov. 21, 2006.

(51) Int. Cl. H05B 37/02

(52) U.S. Cl. 315/363

(57) ABSTRACT

In controlling an ambient lighting element, a host event is detected, a light script associated with the detected event is retrieved and the retrieved light script is rendered in correspondence with the detected event. A user may associate the light script with the event and/or an event type that corresponds to the event. A default association of events and/or event types may be provided, although these default associations may be modified by the user. An event type that corresponds to the event may be identified and a light script associated with the identified event type may be rendered in response to the detected event.

This application claims the benefit of U.S. Provisional Patent Application No. 60/788,466, filed Mar. 31, 2006.

The present system relates to ambient lighting effects that accompany events of a host system.

Koninklijke Philips Electronics N.V. (Philips) and other companies have disclosed means for changing ambient or peripheral lighting to enhance video content for typical home or business applications. Ambient lighting modulated by video content that is provided together with a video display or television has been shown to reduce viewer fatigue and improve realism and depth of experience. Currently, Philips has a line of televisions, including flat panel televisions with ambient lighting, where a frame around the television includes ambient light sources that project ambient light on the back wall that supports or is near the television. Further, light sources separate from the television may also be modulated relative to the video content to produce ambient light that may be similarly controlled.

In a case of a single color light source, modulation of the light source may only be a modulation of the brightness of the light source. A light source capable of producing multi-color light provides an opportunity to modulate many aspects of the multi-color light source based on rendered video including a wide selectable color range per point.

It is an object of the present system to overcome disadvantages in the prior art and/or to provide an ambient lighting effect for events of a host system that are not directly related to the content of rendered video.

The present system provides a method, program and device for controlling an ambient lighting element. In accordance with an embodiment, a host event is detected, a light script associated with the detected event is retrieved and the retrieved light script is rendered in correspondence with the detected event. An ambient lighting element may be controlled in dependence with the rendered light script. A user may associate the light script with the event and/or an event type that corresponds to the event. In one embodiment, a default association of events and/or event types may be provided, although these default associations may be modified by the user. An event type that corresponds to the event may be identified and a light script associated with the identified event type may be rendered in response to the detected event.

Additional data may be associated with the light script in an embodiment. In this embodiment, rendering the retrieved light script may include rendering the light script in accordance with the additional data. The additional data may modulate characteristics of the rendered light script including a color, intensity and/or rate of rendering the light script. In this way, a color, intensity and/or rate of a corresponding ambient lighting effect is modulated by the additional data.

The light script may be repeated in a determined sequence resulting in repeating of the controlled ambient lighting effect. The association of events and/or events types to light scripts may be stored in a table that may be modified by the user.

The present system is explained in further detail, and by way of example, with reference to the accompanying drawings wherein:

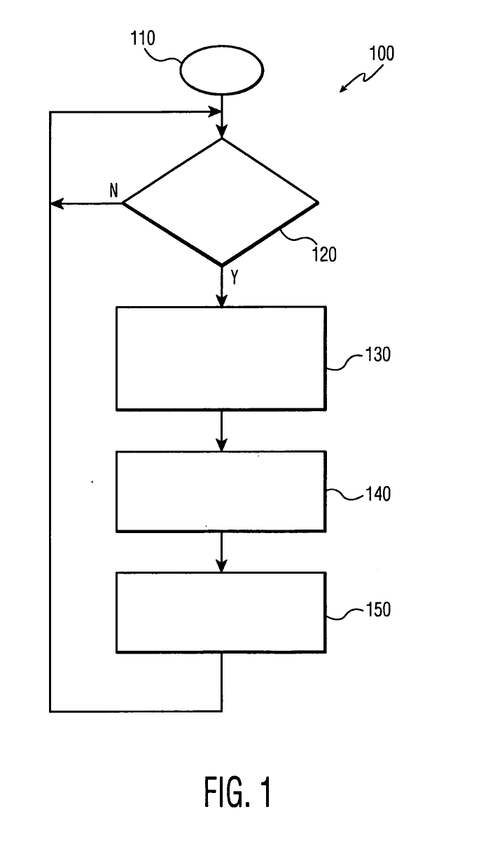

FIG. 1 shows an a flow diagram in accordance with an embodiment of the present system;

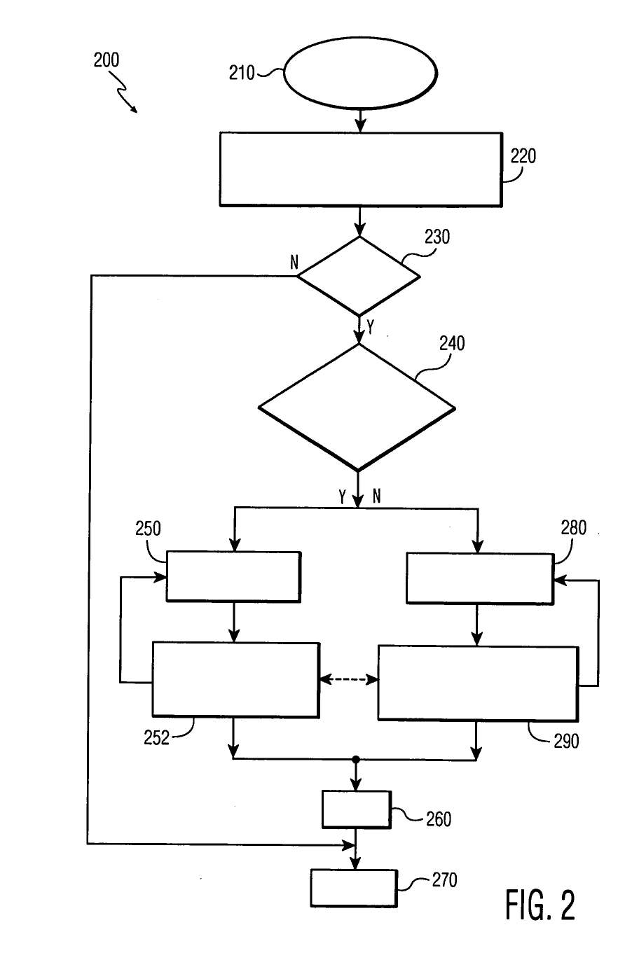

FIG. 2 shows an a flow diagram in accordance with an embodiment of the present system; and

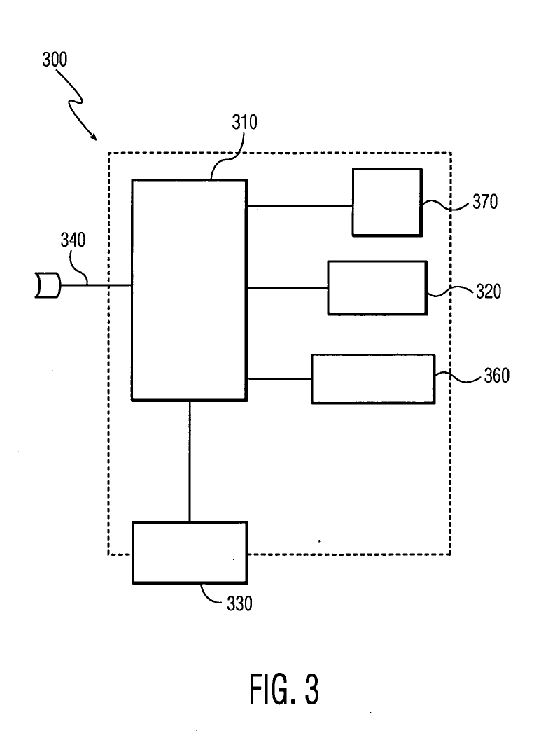

FIG. 3 shows a device in accordance with an embodiment of the present system.

The following are descriptions of illustrative embodiments that when taken in conjunction with the following drawings will demonstrate the above noted features and advantages, as well as further ones. In the following description, for purposes of explanation rather than limitation, specific details are set forth such as the particular architecture, interfaces, techniques, etc., for illustration. However, it will be apparent to those of ordinary skill in the art that other embodiments that depart from these specific details would still be understood to be within the scope of the appended claims. Moreover, for the purpose of clarity, detailed descriptions of well-known devices, circuits, and methods are omitted so as not to obscure the description of the present system.

It should be expressly understood that the drawings are included for illustrative purposes and do not represent the scope of the present system.

FIG. 1 shows a flow diagram 100 in accordance with an embodiment of the present system. During act 110, the process begins which may occur as a result of activation, such as turning on, of an ambient lighting host. As used herein, the term ambient lighting host, or simply host is intended to include a device that has features and/or characteristics that are unrelated to production of ambient lighting. For example, a television, a monitor, an audio player, a personal digital assistant (PDA), cell phone, appliance, and other devices all may be considered a host. The host may include an ambient lighting system in accordance with an embodiment of the present system or may simply be operably coupled to such an ambient lighting system. Act 110 may also occur due to an activation of an ambient lighting feature by a user of the host. For example, the user may decide at some point in time to activate or reactivate the ambient lighting feature in accordance with an embodiment of the present system. Naturally the ambient lighting feature may default to an on-state without user intervention or action.

In any case, during act 120, the system in accordance with an embodiment enters a waiting state to determine if an event of the host is detected. The term event as utilized herein is intended to include manipulations and adjustments to host features and/or circumstances that acquire a user's attention either intentionally or as a result of some event. For example, an event may include turning on/off the host, a change of a setting on the host, entering/exiting a setup feature, confirmation of a feature/setup/mode selection and/or other operations of the host device of the like. Other events may be merely anticipated, such as when a host is turned off, a future event of the device being turned on may be anticipated and thereby, a light script corresponding to an anticipated event may be readied for further operation as described herein. The anticipated events may also arise when triggers are received by the system. For instance, a broadcasting system may send an emergency alert to the present system. Information received by the host may result in the event, anticipated or other not. In another or continuing embodiment, the system may be arranged to receive from an associated communication network a piece of information pushed to the system for a user. In a case wherein an event is not detected or is not imminent, then the system in accordance with the present system may continue to wait or in other words, act 120 may continue.

In accordance with the present system, following detection of an event or an imminent event, the present system identifies the event and/or event type during act 130. Once an event and/or event type is identified, the system in accordance with an embodiment retrieves a light script that corresponds to the event and/or event type during act 140.

Light scripts that are related to video of an audio/visual host that are produced internal or external to the host are known, such as disclosed in International Patent Application Serial No. IB2006/053524 (Attorney Docket No. 003663) filed on Sep. 27, 2006, which is assigned to the assignee hereof, the contents of which are incorporated herein by reference in its entirety. The light script is rendered to control an ambient lighting effect, such as defining and/or altering an ambient lighting color, intensity, duration, and/or other characteristics of the ambient lighting effect.

In accordance with the present system, a light script is arranged to correspond to an event and/or event type. In one embodiment, a table of events and/or event types may be stored that are accessible to the ambient lighting system. The table may contain a list of events and/or event types and light scripts that correspond to the event and/or event types. The system in accordance with an embodiment utilizes the table and the identified event or imminent event to identify and retrieve a light script that corresponds to the event and/or event type.

During act 150, the present system renders the corresponding light script before, during and/or after the event. Rendering the light script results in rendering of an ambient lighting effect under control of the light script. The rendering of the light script may adjust and/or set an ambient lighting effect such as defining and/or altering an ambient lighting color, intensity, duration, and/or other characteristics of one or more ambient lighting elements, such as lighting elements, of the present ambient lighting system. In one embodiment, the light script may define a sequence of pre-edited lighting effects that occur as a result of the rendering of the light script. In a case wherein an imminent event is detected, act 150 may be performed just prior to the events occurrence, may be delayed until the events occurrence, or may occur just after the events occurrence. For example, a switch-on light script may be rendered after turning on of a host device. Upon completion of the rendering of the light script, the present system may return to act 120 to await detection of a further event and/or imminent event.

As an example, an event such as turning on or off the host may trigger rendering of a corresponding light script, such as a switch-on/off light script. This light script may produce an ambient lighting effect that continues through the turn on/off phase. For example, the ambient lighting effect, under control of a switch-on light script may continue up to a point wherein the host is on and ready for further operation, such as through a boot-up period or some portion thereof. The switch-on light script may provide a pleasing lighting presentation (effect) as an introduction to ambient lighting effects related to a video presentation, for example for a host that is a television. In one embodiment, one or more characteristic of the lighting effect may start out soft (e.g., color, intensity, etc.) and slow in transition, and may build (e.g., increase) over time to create anticipation of a continued ambient lighting effect during audio/visual presentations on the television. During shutdown, the ambient lighting effect, under control of a switch-off light script may continue up to a point wherein the host has completed shutdown or some portion thereof. In one embodiment, the ambient lighting effect produced as a result of the switch-off light script may diminish, for example in color, intensity, etc. over time until an end of the effect.

In one embodiment, the event light script and corresponding ambient lighting effect may operate as an echo to an event of the host. For example, in a case wherein a user is changing a setting on the host, a confirmation light script may be rendered in a form of a warning lighting effect, such as an ambient lighting effect and/or sequencing rate of moderate to greater intensity. Illustratively, a red ambient lighting effect and/or sequence, such as a relatively rapid sequencing of ambient light may be rendered in response to an event such as a change in a relatively important feature, such as a change in a child-lock feature. Conversely, an event such as a change in a more mundane feature, such as a time of day setting, may result in a blue lighting effect and/or sequence, such as a relatively slower sequencing of ambient light. In this way, one or more confirmation lighting scripts may be edited in such a way as to convey an importance of a current detected or imminent event. In one embodiment, a same confirmation and/or warning light script may be rendered in both of an important feature change and a mundane feature change with only a change in a rate of sequencing through the light script operating as an indication of an importance of the feature change. In this way, a more rapid sequence of the light script and corresponding light effect may be utilized to indicate a relatively more important feature change.

During an installation event, a marching lighting effect may be produced by a marching light script. For example, a marching lighting effect may include one or more of a rhythmic sequence of colors, intensity, and/or other ambient lighting characteristics. An event that results in a delay of a further operation of the host, such as a blanking period of a host display device, may result in a waiting ambient lighting effect produced as a result of a waiting ambient light script. The waiting ambient lighting effect may be a simple sequence of one or more ambient lighting characteristics, such as a sequence of an on-off-on etc. light color. For example, in one embodiment the waiting ambient light script may produce an ambient light effect similar in impression to a ticking metronome, wherein the ticking is replaced with one or more characteristics of an ambient lighting effect that repetitively sequences, such as a sequence of two states, including on-off, two colors (e.g., red-blue), hi intensity-low intensity, and other ambient lighting sequences of the like.

In this way, an event or event type may be associated with a given light script, rate of rendering the given light script and/or sequencing of a light script in accordance with the present system to produce ambient lighting data including data to control ambient lighting characteristics such as hue, saturation, brightness, color, intensity, rate of change, etc. of one or more ambient lighting elements. Other light scripts, rates of rendering and/or sequences of light scripts, etc. may be associated to other events related to a host as may be readily appreciated by a person of ordinary skill in the art.

As previously described, events, event types, and/or other data related to a rate of rendering of a light script may be associated with light scripts within a look-up table. In accordance with an embodiment, default associations may reside in the table initially. These associations may be modified in accordance with an embodiment of the present system. In another embodiment, events and/or event types may reside in the table without light script associations. In this embodiment, associations may be made and/or modified.

FIG. 2 shows a flow diagram 200 illustrating editing operations of a table of events that also may include event types and associated light scripts in accordance with an embodiment of the present system. During act 210, a user manipulates a user interface in accordance with an embodiment to enter a portion of the user interface for editing the table. The table is reviewed during act 220 including events and/or event types, corresponding light scripts and if present, additional data related to rendering of the corresponding light scripts. The light scripts may be represented in the table with names that identify a potential application of the light script. For example, a particular light script may be identified by a name “warning” to signify that the particular light script may be applicable for an event that should be carefully considered, such as a change in a child-lock feature as described above. Other names that may appear as intuitive to a user may be utilized as names of the light scripts in the table to facilitate an appropriate selection of light scripts for association with events and/or event types as may be readily appreciated by a person of ordinary skill in the art.

In one embodiment, the table may have a default set of events and/or event types and associated light scripts that may be determined by a manufacturer of such a host device. Further, associations may be automatically established based on an available set of light scripts. In this embodiment, the child-lock event for example may have no associated light script if an association has not been previously provided and no “warning” light script is available. Upon a “warning” light script being provided to the host, the association with the child-lock event may be automatically provided. In this and/or an alternate embodiment, an association may be made and/or altered manually by the user as described further herein.

The user may, such as after some review of the table, make a determination whether to modify the table during act 230. Should the user decide to not modify the table, then the portion of the host user interface for editing the table is exited during act 270. The user is provided an opportunity to modify and/or add an event, event type and light script association during act 240. Should the user decide to modify the association portion of the table, then during acts 250, 252, the user may select an event and/or event type and thereafter modify and/or identify a light script for association with the selected event and/or event type. For example, the user may select an association for an event to a light script that has no prior association. The user may alter an association by selecting a different light script for association with the event and/or event type. In one embodiment, an event type, such as a change in significant features of the host may be associated with a selected light script. In this way, every possible event need not be associated to a particular light script for a light script to be rendered during the event. In one embodiment, rendering of a particular light script associated to an event type may be overridden by an association of a particular event to a different light script. In this way, a user is provided an opportunity to select particular associations when desired.

In an embodiment in accordance with the present system, audio content may also be associated with an event. The audio content may be provided as a portion of the light script and/or may be provided simply for association to a light script. In this embodiment, occurrence of a host event results in rendering of a corresponding light script and audio content. The audio content may be rendered in synchronization with a lighting effect resulting from rendering the light script. The association of the audio content to an event and/or event type may also be selected/modified during act 252.

The process of modifying correspondence of events and/or event types to light scripts may be repeated until a determination is made to save the table during act 260. The process may be ended during act 270.

In a case wherein the user decides to not modify the event and light script association during act 240, the user may be provided an opportunity to select and modify a light script and/or data related to the rendering of the light script during acts 280, 290. First a light script is selected and may thereafter be modified. Modifying the light script may include modifying characteristics of the light script including color, intensity, duration, and/or other characteristics of the light script that control an ambient lighting effect (e.g., control of one or more ambient lighting elements) that is generated by rendering the light script. Further, data related to the rendering of the light script may be modified generally, to affect any event that is associated to the light script, and/or modified to change the rendering of the light script for just a particular associated event. For example, data related to a rate of rendering the light script may be modified. Additional data that is modifiable may relate to which of a plurality of potential ambient lighting devices is controlled by the light script and/or a selection of colors, intensity, etc. Other modifications would occur to a person of ordinary skill in the art and are intended to be included in accordance with the present system.

In any event, further light scripts may be selected for modification and/or correspondence of a light script to an event and/or event type may be established. Thereafter, any modification made may be saved during act 260 and the editing of the table is exited during act 270.

Light scripts may be produced external to the system, for example by a light script authoring service that provides a light script for a fee and/or for promotional purposes. For example, light scripts may be provided to promote a particular event, such as selection of a service provided by the host. In this embodiment, a light script may be provided to promote selection of the service through the host. In a fee-based embodiment, event light scripts may be made available on media and/or through a connection, such as a wired or wireless connection, to a remote server, for example accessible though an Internet connection. Using a fee-for-product paradigm as may be readily appreciated, the event light script may be provided. In one embodiment, the light script may be provided on an intermediary system prior to download to a host, such as through a synchronization procedure. In one embodiment, when an event light script is produced outside the system, it may follow a format in which the system directly renders it on one or more ambient lighting devices. The event light script may also be encoded in a pre-defined format. The format may be such that the system has prior knowledge to decode and enable rendering on the one or more ambient lighting devices. For example, in one embodiment such an encoding may be provided in a markup language script. The markup language script may be embedded, such as within the information received by the system. The information may be received, in one embodiment, within information transferred during synchronization.

FIG. 3 shows a device 300 in accordance with an embodiment of the present system. The device 300 may have a processor 310 operationally coupled to a memory 320, one or more ambient lighting elements 360, an input/output (I/O) 340 and a user input device 370. The device 300 may be stand-alone, such as an ambient lighting element, wherein it is operationally coupled to a host, or the device 300 may be partially or wholly incorporated into the host. The device 300 may have a display 330 for interacting within a user interface paradigm supporting operation of the present system as described herein. In an embodiment wherein the device 300 is incorporated into the host, the display 330 may be a display that has additional or separate functionality to support features of the host.

The memory 320 may be any type of device for storing application data as well as other data, such as ambient lighting data, event table data, light scripts, host data (e.g., in an integrated application), audio content, etc. The application data and other data are received by the processor 310 for configuring the processor 310 to perform operation acts in accordance with the present system. The operation acts include rendering a light script to control one or more of the ambient lighting element 360 to display ambient lighting effects in accordance with the present system. The user input 370 may include a keyboard, mouse, or other devices, including touch sensitive displays, which may be stand alone or be a part of a system, such as part of a personal computer, personal digital assistant, and display device such as a television, for communicating with the processor 310 via any type of link, such as a wired or wireless link. For example, the user input 370 may be utilized for editing the event and light script table. Clearly the processor 310, memory 320, display 330, ambient lighting element 360 and/or user input 370 may all or partly be a portion of a television platform, such as a stand-alone television, may be a portion of another host device, or may be standalone devices.

The methods of the present system are particularly suited to be carried out by a computer software program, such computer software program preferably containing modules corresponding to the individual steps or acts of the methods. Such software may of course be embodied in a computer-readable medium, such as an integrated chip, a peripheral device or memory, such as the memory 320 or other memory coupled to the processor 310.

The computer-readable medium and/or memory 320 may be any recordable medium (e.g., RAM, ROM, removable memory, CD-ROM, hard drives, DVD, floppy disks or memory cards) or may be a transmission medium (e.g., a network comprising fiber-optics, the world-wide web, cables, or a wireless channel using time-division multiple access, code-division multiple access, or other radio-frequency channel). Any medium known or developed that can provide information suitable for use with a computer system may be used as the computer-readable medium and/or memory 320.

The memory 320 configures processor 310 to implement the methods, operational acts, and functions disclosed herein. The memory may be distributed or local and the processor 310, where additional processors may be provided, may also be distributed, as for example based within the ambient lighting elements, or may be singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory 320, for instance, because the processor 310 may retrieve the information from the network for operation in accordance with the present system.

The processor 310 is capable of providing control signals and/or performing operations in response to input signals from the user input 370 and executing instructions stored in the memory 320. The processor 310 may be an application-specific or general-use integrated circuit(s). Further, the processor 310 may be a dedicated processor for performing in accordance with the present system or may be a general-purpose processor wherein only one of many functions operates for performing in accordance with the present system. The processor 310 may operate utilizing a program portion, multiple program segments, or may be a hardware device utilizing a dedicated or multi-purpose integrated circuit.

The I/O 340 may be utilized for requesting and/or receiving one or more light scripts, and/or for other operations as described above. For example, the I/O 340 may operate as a portion of the fee-based paradigm, for example for accessing an external network as described herein.

Of course, it is to be appreciated that any one of the above embodiments or processes may be combined with one or more other embodiments or processes or be separated in accordance with the present system.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts or steps is intended to be required unless specifically indicated.

1. A method of controlling an ambient lighting element, the method comprising acts of:
detecting a host event;
retrieving a light script associated with the detected event; and
rendering the retrieved light script in correspondence with the detected event.

2. The method of claim 1, comprising an act of controlling an ambient lighting element in dependence with the rendered light script.

3. The method of claim 1, comprising an act of associating the light script with the event.

4. The method of claim 1, comprising an act of associating the light script with an event type that corresponds to the event.

5. The method of claim 4, comprising an act of identifying an event type that corresponds to the event, wherein the act of retrieving comprises an act of retrieving a light script associated with the identified event type.

6. The method of claim 1, wherein additional data is associated with the light script and wherein the act of rendering the retrieved light script comprises an act of rendering the light script in accordance with the additional data.

7. The method of claim 6, wherein the additional data modulates at least one of a color, intensity and rate of an ambient lighting effect produced by rendering the light script.

8. The method of claim 1, wherein the act of rendering the retrieved light script comprises an act of repeating the rendering of the light script in a determined sequence.

9. The method of claim 1, comprising an act of editing an association of the event with the light script, wherein the act of retrieving the light script comprises an act of retrieving a light script in accordance with the edited association.

10. An application embodied on a computer readable medium configured to control an ambient lighting element, the application comprising:
a portion configured to detect a host event;
a portion configured to retrieve a light script associated with the detected event; and
a portion configured to render the retrieved light script in correspondence with the detected event.

11. The application of claim 10, comprising a portion configured to control an ambient lighting element in dependence with the rendered light script.

12. The application of claim 10, comprising a portion configured to associate the light script with the event.

13. The application of claim 10, comprising a portion configured to associate the light script with an event type that corresponds to the event.

14. The application of claim 13, comprising a portion configured to identify an event type that corresponds to the event, wherein the portion configured to retrieve comprises a portion configured to retrieve a light script associated with the identified event type.

15. The application of claim 10, wherein additional data is associated with the light script and wherein the portion configured to render the retrieved light script comprises a portion configured to render the light script in accordance with the additional data.

16. A device for controlling an ambient lighting element, the device comprising:
a memory 320; and
a processor 310 operationally coupled to the memory 320, wherein the processor 310 is configured to:
detect a host event;
retrieve a light script associated with the detected event; and
render the retrieved light script in correspondence with the detected event.

17. The device of claim 16, wherein the processor 310 is configured to associate the light script with at least one of the event and an event type that corresponds to the event.

18. The device of claim 16, wherein additional data is associated with the light script and wherein the portion configured to render the retrieved light script comprises a portion configured to render the light script in accordance with the additional data.

19. The device of claim 16, wherein the device is incorporated into a host 300 that has additional functionality.

20. The device of claim 19, wherein the host 300 renders at least one of auditory and visual stimulus as the additional functionality.
